(19) United States
(12) Patent Application Publication
(10) Pub. No.: US 2023/0086628 A1
(43) Pub. Date: Mar. 23, 2023

(54) ABNORMAL DATA GENERATION DEVICE, ABNORMAL DATA GENERATION MODEL LEARNING DEVICE, ABNORMAL DATA GENERATION METHOD, ABNORMAL DATA GENERATION MODEL LEARNING METHOD, AND PROGRAM

(71) Applicant: NIPPON TELEGRAPH AND TELEPHONE CORPORATION, Tokyo (JP)

(72) Inventors: Yuma KOIZUMI, Tokyo (JP); Shoichiro SAITO, Tokyo (JP); Hisashi UEMATSU, Tokyo (JP); Shin MURATA, Tokyo (JP)

(73) Assignee: NIPPON TELEGRAPH AND TELEPHONE CORPORATION, Tokyo (JP)

(21) Appl. No.: 17/798,849

(22) PCT Filed: Feb. 12, 2020
(86) PCT No.: PCT/JP2020/005248

§ 371 Date: Aug. 10, 2022

(51) Int. Cl. G06K 9/62; G06N 3/04

(52) U.S. Cl. CPC G06K 9/6265; G06N 3/0454

(57) ABSTRACT

Provided is an abnormal data generation device capable of generating highly accurate abnormal data. The abnormal data generation device includes an abnormal data generation unit for generating pseudo generated data of abnormal data that has, in the same latent space, a normal distribution as a normal data generation model and an abnormal distribution expressed as a complementary set of the normal distribution and that is optimized such that pseudo generated data cannot be discriminated from observed actual abnormal data by a latent variable sampled from the abnormal distribution.

### TECHNICAL FIELD

The present invention relates to an abnormal data generation device for generating abnormal data in anomaly detection, an abnormal data generation model learning device for learning a model for generating abnormal data, an abnormal data generation method, an abnormal data generation model learning method, and a program.

### BACKGROUND ART

### Problem Establishment of Anomaly Detection

Anomaly detection is a technology for determining whether an observed signal X∈R^{H×W} is normal or abnormal (NPL 1 and NPL 2). Although there are no restrictions on the format of X, description is given on the assumption that X is, for example, an amplitude spectrogram of a time-frequency converted image or audio signal. When X is an image, H and W are the numbers of vertical and horizontal pixels, respectively. When X is an amplitude spectrogram, H and W are the number of frequency bins and the number of time frames, respectively. In anomaly detection, when an anomaly score calculated from X is larger than a threshold φ defined in advance, a monitoring target is determined to be abnormal, and when the anomaly score is smaller than the threshold φ, the monitoring target is determined to be normal.

$$\begin{matrix}[ Math . 1 ] & \\ 𝒵 ( X ; {θ}_{a} , ϕ ) = \{ \begin{matrix}Normal & ( ( X ; {θ}_{a} ) < ϕ ) \\ Anomaly & ( ( X ; {θ}_{a} ) \geq ϕ )\end{matrix} & ( 1 )\end{matrix}$$

where A:R^{T×Ω}→R is an anomaly score calculator having a parameter θₐ. One difficulty of learning in anomaly detection is that abnormal data is difficult to collect. When no abnormal data is available, a learning method based on outlier detection is often adopted. In other words, only normal data is used as training data, and the statistical model is made to learn the normalness (for example, the model for generating normal data), and if the observed signal does not look normal, it is considered abnormal. As a method for calculating the anomaly level using deep learning based on outlier detection, a method using an autoencoder (AE) is known (NPL 2 and NPL 3). The method for calculating the anomaly level using AE is as follows.

$$\begin{matrix}[ Math . 2 ] & \\ 𝒜 ( X ; {θ}_{a} ) = \frac{1}{HW} {‖ X - AE ( X ; {θ}_{a} ) ‖}_{F}^{2} & ( 2 )\end{matrix}$$

where [symbol] _{F} is the Frobenius norm. In order to learn θₐ such that an anomaly score of normal data decreases with only the normal data being learning data, θₐ is trained so as to minimize an average reconstruction error of normal data.

$$[ Math . 3 ]$$

$${ℒ}_{{θ}_{a}}^{AE} = \frac{1}{N} {\sum }_{n = 1}^{N} ( {X}_{n}^{-} ; {θ}_{a} ) \qquad ( 3 )$$

where N is a mini batch size of normal data, and X⁻ₙ is the n-th normal data in a mini batch.

### Supervised Anomaly Detection and Abnormal Data Augmentation

In the operation of an anomaly detection system, abnormal data may be obtained in rare cases. In order to improve detection accuracy, it is desired to use the abnormal data for learning. For this, the cost function in Equation (2) needs to be changed. The following is an example of the cost function that decreases an anomaly score of normal data and increases an anomaly score of abnormal data.

$$[ Math . 4 ]$$

$${ℒ}_{{θ}_{a}}^{AE} = \frac{1}{N} {\sum }_{n = 1}^{N} ( {X}_{n}^{-} ; {θ}_{a} ) + {clip [ \frac{1}{M} {\sum }_{m = 1}^{M} ( {X}_{m}^{+} ; {θ}_{a} ) ]}_{β} \qquad ( 4 )$$

where clip[x]_{β}=β·tanh(x/β) is established, and {X⁺ₘ}^{M}ₘ₌₁ is a mini batch of abnormal data. One problem of learning of an anomaly detector using abnormal data is the number of samples of abnormal data. Because abnormal data occurs only rarely, a sufficient amount of learning data cannot be prepared. In this case, there are methods for augmenting a small number of pieces of obtained abnormal data to increase the number of samples. Examples of the methods include a method for adding a normal random number to anomaly samples and a method for rotating an image.

However, the method for adding a normal random number to anomaly samples, for example, assumes that a generation distribution of anomaly sound is a normal distribution whose average value is observed abnormal data, but in many cases, this assumption is not satisfied.

### CITATION LIST

### Non Patent Literature

[NPL 1] V. Chandola, A. Banerjee, and V. Kumar “Anomaly detection: A survey”, ACM Computing Surveys, 2009.

[NPL 2] R. Chalapathy and S. Chawla, “Deep Learning for Anomaly Detection: A Survey”, arXiv preprint, arXiv:1901.03407, 2019.
[NPL 3] Y. Koizumi, S. Saito, H. Uematsu, Y. Kawachi, and N. Harada, “Unsupervised Detection of Anomalous Sound on the basis of Deep Learning and the Neyman-Pearson Lemma”, IEEE/ACM Transactions on Audio, Speech, and Language Processing, Vol. 27-1, pp. 212-224, 2019.
[NPL 4] J. An and S. Cho, “Variational Autoencoder based Anomaly Detection using Reconstruction Probability”, 2015.
[NPL 5] Y. Kawachi, Y. Koizumi, and N. Harada, “Complementary Set Variational AutoEncoder for Supervised Anomaly Detection”, Proc. of International Conference on Acoustics, Speech and Signal Processing (ICASSP), 2018.

### [NPL 6] P. Bergmann, M. Fauser, D. Sattlegger, C. Steger, “MVTec AD-A Comprehensive Real World Dataset for Unsupervised Anomaly Detection”, Proc. of IEEE Conference on Computer Vision and Pattern Recognition (CVPR), 2019.

### SUMMARY OF THE INVENTION

### Technical Problem

As described above, because abnormal data occurs only rarely, the augmentation of abnormal data is needed to prepare a sufficient amount of learning data. However, no method for accurately generating abnormal data has been known.

In view of the above, it is an object of the present invention to provide an abnormal data generation device capable of generating highly accurate abnormal data.

### Means for Solving the Problem

An abnormal data generation device in the present invention includes an abnormal data generation unit. The abnormal data generation unit generates pseudo generated data of abnormal data, which has, in the same latent space, a normal distribution as a normal data generation model and an abnormal distribution expressed as a complementary set of the normal distribution and is optimized such that pseudo generated data cannot be discriminated from observed actual abnormal data by a latent variable sampled from the abnormal distribution.

### Effects of the Invention

The abnormal data generation device in the present invention can generate highly accurate abnormal data.

### BRIEF DESCRIPTION OF DRAWINGS

FIG. 1 is a block diagram illustrating a configuration of an abnormal data generation model learning device according to Embodiment 1.

FIG. 2 is a flowchart illustrating an operation of an abnormal data generation model learning device in Embodiment 1.

FIG. 3 is a diagram illustrating Generation Example 1 of abnormal data.

FIG. 4 is a diagram illustrating Generation Example 2 of abnormal data.

FIG. 5 is a block diagram illustrating a configuration of an abnormal data generation device in Embodiment 1.

FIG. 6 is a flowchart illustrating an operation of the abnormal data generation device in Embodiment 1.

FIG. 7 is a diagram illustrating a functional configuration example of a computer.

### DESCRIPTION OF EMBODIMENTS

Embodiments of the present invention are described in detail below. Note that configurational units having the same functions are denoted by the same reference numerals, and overlapping descriptions are omitted.

### Embodiment 1

### Summary

In order to improve the accuracy of anomaly detection, it is essential to introduce supervised learning, which collects and uses a massive amount of both of normal data and abnormal data for learning. However, the occurrence frequency of abnormal data is significantly small, and it is impossible to collect a sufficient amount of learning data in most cases. In view of this, a method for augmenting a small amount of obtained abnormal data (data augmentation) to secure the amount of abnormal data is necessary. Conventionally, methods have been used to augment abnormal data by adding Gaussian random numbers or by using rotation or expansion and contraction, but there is no guarantee that the abnormal data was generated from the same probability distribution as the abnormal data. The present embodiment discloses a device and a method for explicitly learning a generation distribution of abnormal data and pseudo-generating abnormal data therefrom. As a fundamental element, “complementary-set variational autoencoder (CVAE)” is used to model abnormal data. The complementary-set variational autoencoder does not assume that abnormal data is pseudo-generated and the generated data is used for learning, and hence the accuracy of generating complex data such as images has not yet been discussed. In fact, it can be seen that the complementary-set variational autoencoder cannot be used to generate details.

In order to solve the problem, the present embodiment discloses an adversarial complementary-set variational autoencoder (CVAE-GAN) in which a cost function of a generative adversarial network (GAN) is introduced for learning of the CVAE. Points of the present invention are:

(i) using a CVAE to generate abnormal data (using CVAE for abnormal data augmentation problem); and
(ii) combining a GAN for learning of the CVAE (to obtain high-definition generated data). In experiments, an open data set of abnormal images was used such that a natural abnormal image that is not present in a learning data set can be generated.

The present embodiment discloses a device and a method for using a small amount (about 1 to 10 samples) of observed abnormal data to estimate a generation model of abnormal data and pseudo-generate abnormal data. The present embodiment provides a generation model of abnormal sound by developing a complementary-set variational autoencoder (NPL 5), which has been proposed as a statistical model for supervised anomaly detection.

A variational autoencoder (VAE), a complementary-set variational autoencoder (CVAE), a generative adversarial network (GAN), and an adversarial complementary-set variational autoencoder (CVAE-GAN), which are technologies that form the basis of the operation of an abnormal data generation model learning device in the present embodiment are described below.

### Variational Autoencoder

The VAE is a method for learning a generation model p(X|X) of X (former X is bold and italic X and latter X is X in script) on the assumption that learning data X={Xⱼ}^{J}ⱼ₌₁ for J samples has been obtained. VAE assumes a generation process for X in which (i) latent variable zₙ∈R^{D} is generated from a prior distribution p(z) and (ii) observed data Xₙ is generated from a conditional distribution p(X|zₙ). These distributions are considered as parametrized distributions of q_{φ}(z|X) and p_{θ}(X|z), respectively, and each is modeled by a neural network. In other words, the former is the encoder that estimates the distribution of the hidden variables from the observed variables, and the latter is the decoder that estimates the distribution of the observed variables from the hidden variables.

By using the two networks, the generation model of X is described as follow.

### [Math. 5]

p_{θ,ϕ}(X)=∫p_{θ}(X [symbol] )q_{ϕ}( [symbol] |X)d [symbol] . . . (5)

Instead of learning p_{θ,ϕ}(X) on the basis of Likelihood maximization criteria for X, p_{θ,ϕ}(X) is learned so as to maximize the evidence lower bound (ELBO).

$$[ Math . 6 ]$$

$${ℒ}^{VAE} = - \frac{1}{N} {\sum }_{n = 1}^{N} {𝒱}_{θ , ϕ} ( {X}_{n} ) \qquad ( 6 )$$

$${𝒱}_{θ , ϕ} ( X ) = \frac{1}{K} {\sum }_{k = 1}^{K} ln {p}_{8} ( X \vert {( k )}^{} ) - KL [ {q}_{ϕ} ( \vert X ) ∥ p ( ) ] \qquad ( 7 )$$

where p(z) is a prior distribution of z, N is a batch size, K is the number of samples for approximating expectation operation by sampling, and z^{(k)} is a variable sampled as z^{(k)}˜q_{φ}(z|X).

In the VAE, a DNN that expresses an encoder and a decoder is used as follows. When p(z) is designed by a standard Gaussian distribution N(z;0,I), the encoder estimates an average μ=(μ₁, . . . , μ_{D}) and a variance σ=(σ₁, . . . , 94 _{D}) of a Gaussian distribution that would have generated X. In this case, the second term of Equation (7) can be calculated as follows.

$$[ Math . 7 ]$$

$$KL [ {q}_{ϕ} ( \vert X ) ∥ p ( ) ] = \frac{1}{2} {\sum }_{d = 1}^{D} {μ}_{d}^{2} + {σ}_{d}^{2} - ln {σ}_{d}^{2} - 1 \qquad ( 8 )$$

The decoder is a network for restoring X as \hat{ }X(k) from z(k). Various likelihood functions can be used in this case, and the typical one is point-wise Gaussian. This can be interpreted as the average of the squared errors for each pixel if X is an image, and is calculated as follows.

$$[ Math . 8 ]$$

$$ln {p}_{θ} ( X \vert {( k )}^{} ) ∝ - \frac{1}{HW} {‖ X - {\hat{X}}^{( k )} ‖}_{p}^{2} \qquad ( 9 )$$

This corresponds to an anomaly score in the AE expressed by Equation (2), and hence the VAE is used as an anomaly score calculator in anomaly detection in many cases (NPL 4).

### Complementary-set Variational Autoencoder

The CVAE (NPL 5) is an extension of the VAE for supervised anomaly detection (using both of normal data and abnormal data for learning). The underlying idea of CVAE is that an anomaly is a complementary set of the normal, in other words, an anomaly is defined as “anything that is not normal”. Therefore, the generating distribution of the abnormality should have a lower likelihood in the region where the probability of being normal is high, and a higher likelihood than the normal distribution in the region where the probability of being normal is low. Kawachi, et al. proposed the following complementary-set distribution as a general form of a probability distribution satisfying such constraints.

$$[ Math . 9 ]$$

$$( x ) = \frac{1}{} {p}_{w} ( x ) ( {max}_{x} , {p}_{n} ( {x}^{′} ) - {p}_{n} ( x ) ) \qquad ( 10 )$$

where pₙ(x) is a normal distribution and p_{w}(x) is a universal set distribution. As a learning method for a VAE using this, CVAE is disclosed, in which the latent variables of normal data are learned to minimize the KL information with the standard Gaussian distribution N(z;0,I) as in normal VAE, and the latent variables of abnormal data are learned to minimize the KL information with the complementary-set distribution C(x). A cost function used to learn a CVAE is as follows.

$$[ Math . 10 ]$$

$${ℒ}^{CVAR} = - \frac{1}{N} {\sum }_{n = 1}^{N} {𝒱}_{θ , ϕ} ( {X}_{n}^{( - )} ) - \frac{1}{M} {\sum }_{m = 1}^{M} {𝒱}_{θ , ϕ}^{( + )} ( {X}_{m}^{( + )} ) \qquad ( 11 )$$

$${𝒱}_{θ , ϕ}^{( + )} ( X ) = \frac{1}{K} {\sum }_{k = 1}^{K} ln {p}_{θ} ( X \vert {( k )}^{} ) - KL [ {q}_{ϕ} ( \vert X ) ∥ ( ) ] \qquad ( 12 )$$

The implementation of Kawachi, et al. uses a complementary-set distribution, where pₙ(x) is a standard Gaussian distribution and p_{w}(x) is a Gaussian distribution with mean 0 and variance s². In this case, the complementary-set distribution is as follows.

$$[ Math . 11 ]$$

$$( x ; s ) = \frac{1}{} ( x ; 0 , s ) ( \frac{1}{\sqrt{2 π}} - ( x ; 0 , 1 ) ) \qquad ( 13 )$$

$$= \frac{1}{\sqrt{2 π}} ( 1 - \frac{1}{\sqrt{{s}^{2} + 1}} ) \qquad ( 14 )$$

KL[q_{φ}(z|X) [symbol] C_{N}(z)] can be approximated and calculated as follows by using the approximation of ln(x+1/(2π))=−ln2π+2πx.

$$[ Math . 12 ]$$

$$KL [ {q}_{ϕ} ( \vert X ) ∥ ( z ) ] \approx \frac{1}{D} {\sum }_{d = 1}^{D} \sqrt{\frac{2 π}{{σ}_{d}^{2} + 1}} exp ( - \frac{{μ}_{d}^{2}}{2 ( {σ}_{d}^{2} + 1 )} ) + \frac{{μ}_{d}^{2} + {σ}_{d}^{2}}{2 {s}^{2}} - ln {σ}_{d} + C \qquad ( 15 )$$

where C is a constant term unrelated to μ and σ.

The CVAE is a generation model, and hence it is possible to generate anomaly data by generating random numbers from complementary-set distributions and restoring the observed signals with a trained decoder. However, image generation by the decoder of VAE is known to have the problem that the generated image is blurred. Since CVAE was not designed to pseudo-generate anomalous data and use the generated data for training, the accuracy of generating complex X such as images has not been discussed (in practice, it is found that the generation of fine details is not possible). (It is clear that the generation of details is not possible.

### Generative Adversarial Network

On the other hand, it is known that a generative adversarial network (GAN) can output high-definition images.

### Adversarial complementary-set variational autoencoder

In view of the prior research, in order to overcome the problem of generation of abnormal data by the CVAE, the present embodiment discloses an adversarial complementary-set variational autoencoder (CVAE-GAN). A cost function in the CVAE-GAN is obtained by adding a cost function in the GAN to a cost function in the CVAE. In the GAN, in addition to a network for data generation, a network D for discriminating whether input data is real or generated pseudo data is used. In the present invention, D is a network having a parameter ψ, and when 0≤D_{ψ}(X)≤1 is small, X is true data while when 0≤D_{ψ}(X)≤1 is large, X is generated data.

Various derivatives of the GAN cost function have been proposed, and any derivative of the GAN cost function may be used in the present invention. For example, the cost function in the form of Wasserstein GAN (WGAN) can be used. When using the cost of WGAN, the encoder and decoder should be trained to minimize the following cost function.

$$[ Math . 13 ]$$

$${ℒ}^{CVAE - GAN} = {ℒ}^{CVAE} - {ℒ}^{WGAN} \qquad ( 16 )$$

$${ℒ}^{WGAN} = {𝒱}^{true} - {𝒱}^{gen} \qquad ( 17 )$$

$${𝒱}^{true} = {\underbrace{\frac{1}{N} {\sum }_{n = 1}^{N} {𝒟}_{ψ} ( {X}_{u}^{-} ) + \frac{1}{M} {\sum }_{m = 1}^{M} {𝒟}_{ψ} ( {X}_{m}^{+} )}}_{True data} \qquad ( 18 )$$

$${𝒱}^{gen} = {\underbrace{\frac{1}{N} {\sum }_{n = 1}^{N} {𝒟}_{ψ} ( {\hat{X}}_{n}^{-} ) + \frac{1}{M} {\sum }_{m = 1}^{M} {𝒟}_{ψ} ( {\hat{X}}_{m}^{+} )}}_{Reconstructed data} + {\underbrace{\frac{1}{N} {\sum }_{n = 1}^{N} {𝒟}_{ψ} ( {\tilde{X}}_{n}^{-} ) + \frac{1}{M} {\sum }_{m = 1}^{M} {𝒟}_{ψ} ( {\tilde{X}}_{m}^{+} )}}_{Data generated from random number} \qquad ( 19 )$$

However, {˜X⁻ₙ}^{N}ₙ₌₁ and {˜X⁺ₘ}^{M}ₘ₌₁ are data generated from {˜z⁻ₙ}^{N}ₙ₌₁ and {˜z⁺_{m}}^{M}ₘ₌₁, respectively, using a decoder, and each dimension of ˜z⁻ₙ and ˜z⁺ₘ is a random number generated by ˜z⁻_{n,d}˜N(z;0, 1) and ˜z⁺_{m,d}˜C_{N}(x;s). The parameter ψ of D is trained to minimize the LWGAN. By learning in this way, we can generate anomalous data that is indistinguishable from the real anomalous data, while guaranteeing that the pseudo-generated data is generated from the probability distribution of the latent variables of the anomalous data, C_{N}(x;s), unlike conventional techniques.

Once the encoder and decoder have been trained, we can generate random numbers of latent variables in ˜z⁻_{m,d}˜C_{N}(x;s) as in training, generate pseudo-generated anomaly data {˜X⁺ₘ}^{M}ₘ₌₁ at the encoder, and train the anomaly calculator A using a cost function such as Equation (4).

### <Abnormal Data Generation Model Learning Device 1>

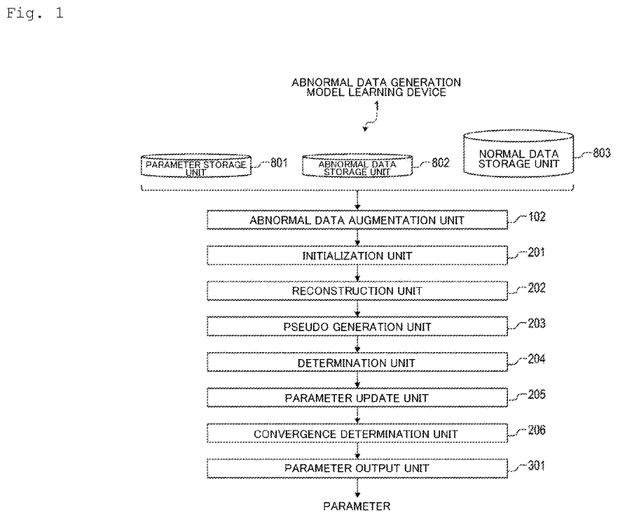

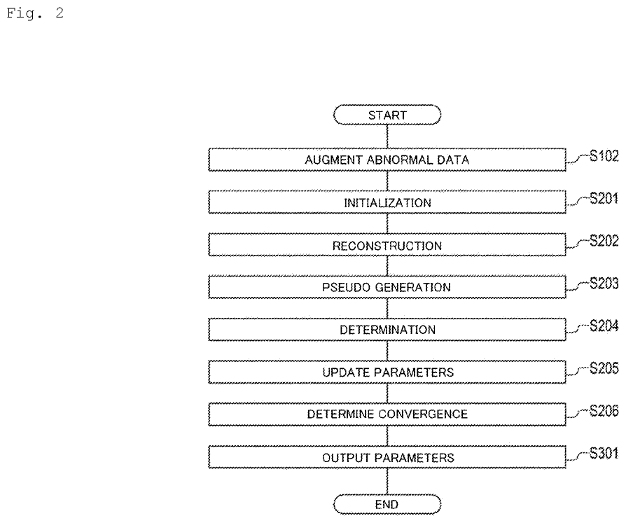

As illustrated in FIG. 1, an abnormal data generation model learning device 1 in the present embodiment includes a parameter storage unit 801, an abnormal data storage unit 802, a normal data storage unit 803, an abnormal data augmentation unit 102, an initialization unit 201, a reconstruction unit 202, a pseudo generation unit 203, a determination unit 204, a parameter update unit 205, a convergence determination unit 206, and a parameter output unit 301. Note that FIG. 1 illustrates the parameter storage unit 801 for storing initial values of parameters therein in advance, the abnormal data storage unit 802 for storing abnormal data (observed data) used for learning therein in advance, and the normal data storage unit 803 for storing normal data (observed data) used for learning therein advance, but these storage areas may exist in the abnormal data generation model learning device 1 or may be included in another device. In the present embodiment, description is given on the assumption that the parameter storage unit 801, the abnormal data storage unit 802, and the normal data storage unit 803 are included in an external device. In the abnormal data generation model learning device 1, initial values of parameters, observed normal data, and observed abnormal data are input from the parameter storage unit 801, the abnormal data storage unit 802, and the normal data storage unit 803. The various parameters can be set to about N=M=50 and s=5. Referring to FIG. 2, the operations of the configuration requirements are described below.

### Abnormal Data Augmentation Unit 102

The abnormal data augmentation unit 102 augments abnormal data (S102). When the original number of pieces of abnormal data is sufficient, the abnormal data augmentation unit 102 and step S102 can be omitted. For example, the abnormal data augmentation unit 102 augments abnormal data by using rotation for images and extraction and contraction in the time frequency direction for sound. Note that observed normal data, observed abnormal data, and abnormal data augmented at step S102 are hereinafter collectively referred to as observed data.

### Initialization Unit 201

The initialization unit 201 initializes random numbers of various kinds of networks (S201).

### Reconstruction Unit 202

The reconstruction unit 202 acquires observed data including observed normal data and observed abnormal data, and encodes and decodes the observed data by an autoencoder type DNN to acquire reconstructed data of normal data and abnormal data (S202).

More specifically, the reconstruction unit 202 reconstructs randomly selected mini-batches of normal and abnormal data (for example, mini-batches defined by the number of batches represented by N and M in Equation (11)) using VAE to acquire reconstructed data of normal data and abnormal data.

### Pseudo Generation Unit 203

The pseudo generation unit 203 acquires pseudo generated data of normal data and pseudo generated data of abnormal data on the basis of a complementary-set variational autoencoder (S203). More specifically, the pseudo generation unit 203 acquires pseudo generated data of normal data on the basis of randomly generated latent variables from the probability distribution of latent variables trained to have a small difference from the standard Gaussian distribution, and acquires pseudo generated data of abnormal data on the basis of randomly generated latent variables from the probability distribution of latent variables trained to have a small difference from the complementary-set distribution of normal data.

### Determination Unit 204

The determination unit 204 inputs the observed data, the reconstructed data, and the pseudo generated data to a classifier D for discriminating whether input data is observed data, and acquires a determination result (S204).

### Parameter Update Unit 205

The parameter update unit 205 updates, on the basis of an adversarial complementary-set variational autoencoder obtained by combining a complementary-set variational autoencoder and a generative adversarial network, a parameter of a classifier for discriminating whether input data is observed data and parameters of an encoder and a decoder for reconstruction and pseudo generation (S205).

More specifically, the parameter update unit 205 updates a parameter ψ in the classifier D such that the cost function (Equation (17) : L^{MGAN}=V^{true}−V^{gen}) becomes smaller as the classifier makes a more correct decision. The parameter update unit 205 updates the parameters of the encoder and the decoder for reconstruction and pseudo generation such that the cost function in Equation (16) decreases, in other words, such that the cost function L^{CVAE} in Equation (16) decreases and the cost function L^{WGAN} increases (S205).

### Convergence Determination Unit 206

The convergence determination unit 206 determines whether the learning at steps S202 to S205 has converged (S206). When the determination result at step S206 is “converged”, the learning is finished and the flow proceeds to step S301. Otherwise, the flow returns to step S202.

### Parameter Output Unit 301

The parameter output unit 301 outputs trained parameters (S301).

### EXECUTION RESULT EXAMPLES

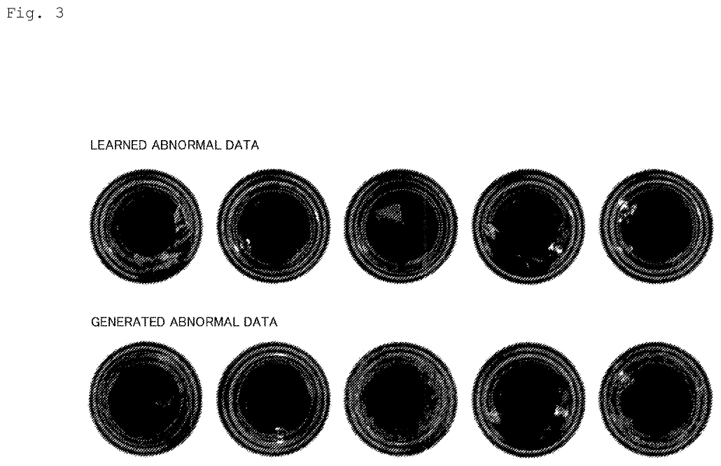

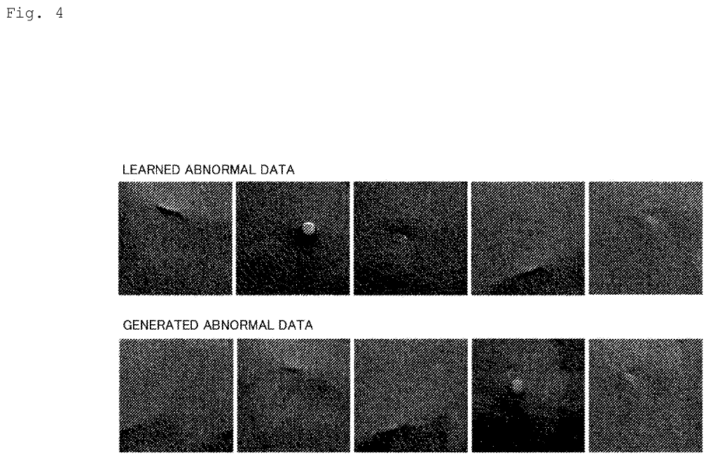

In order to verify the effectiveness in the present embodiment, an open data set MVTec-AD for image anomaly detection (NPL 6) was used to perform a pseudo generation experiment of abnormal data. As operation check, data of “bottle” and “leather” in the data set was used. Each image was converted to gray scale, and the size was resized to 128×128 for use. As abnormal data, five images of “bottle” (the shape of the mouth of a bottle) and “leather” (the surface of a leather product) each were used and rotated by one degree such that the data was expanded to a total of 1,800 samples. FIGS. 3 and 4 illustrate generated anomaly samples. It is understood that the anomalies are similar to the original anomaly data, and the anomalies appear in different locations.

### Abnormal Data Generation Device 2

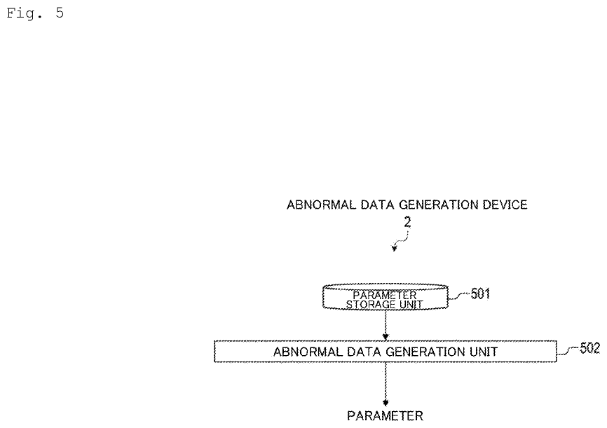

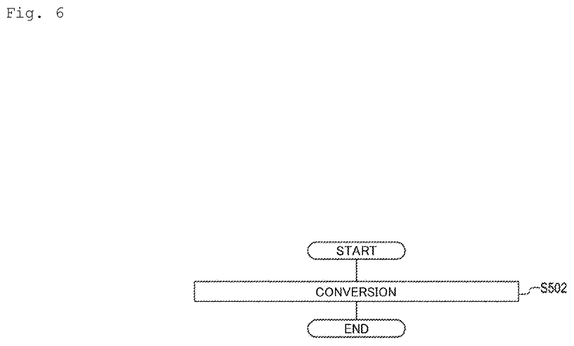

Referring to FIG. 5, the configuration of the abnormal data generation device 2 for generating abnormal data by using trained parameters is described below. As illustrated in FIG. 5, the abnormal data generation device 2 in the present embodiment includes an abnormal data generation unit 502. Note that FIG. 5 illustrates a parameter storage unit 501 for storing parameters trained and output by the abnormal data generation model learning device 1 therein in advance, but this storage area may exist in the abnormal data generation device 2 or may be included in another device. In the present embodiment, description is given on the assumption that the parameter storage unit 501 is included in an external device. Referring to FIG. 6, the operation of the abnormal data generation unit 502 is described below.

### Abnormal data generation unit 502

The abnormal data generation unit 502 generates pseudo generated data of abnormal data that has, in the same latent space, a normal distribution as a normal data generation model and an abnormal distribution expressed as a complementary set of the normal distribution and that is optimized such that pseudo generated data cannot be discriminated from observed actual abnormal data by a latent variable sampled from the abnormal distribution (S502).

The abnormal data generation unit 502 encodes and decodes observed data including observed abnormal data by an autoencoder type DNN to generate reconstructed data of abnormal data optimized such that pseudo generated data cannot be discriminated from observed actual abnormal data (S502).

In this case, the abnormal data generation unit 502 is a decoder for generating pseudo generated data, in which a parameter is updated and trained such that the cost function that becomes smaller as a classifier D for discriminating whether input abnormal data is observed abnormal data makes a more correct decision becomes larger (S502).

### Supplementation

The device in the present invention includes, for example, as a single hardware entity, an input unit to which a keyboard can be connected, an output unit to which a liquid crystal display can be connected, a communication unit to which a communication device (for example, communication cable) capable of communicating with the outside of the hardware entity can be connected, a central processing unit (CPU; may include a cache memory and a register), a RAM and a ROM as memories, an external storage device as a hard disk, and a bus connected such that data among the input unit, the output unit, the communication unit, the CPU, the RAM, the ROM, and the external storage device can be exchanged. If necessary, the hardware entity may be provided with a device (drive) capable of reading and writing a recording medium such as a CD-ROM. Examples of the physical entity having such hardware resources include a general-purpose computer.

In the external storage device in the hardware entity, programs necessary for implementing the above-mentioned functions and data necessary for processing of the programs are stored (not limited to the external storage device, for example, the program may be stored in ROM, which is a read-only storage device). Data obtained by the processing of the programs is stored in the RAM or the external storage device as appropriate.

In the hardware entity, each program stored in an external storage device (or ROM, etc.) and the data necessary for processing this program are read into memory as necessary, and are interpreted, executed, and processed by the CPU as appropriate. As a result, the CPU implements predetermined functions (each of the constituent requirements described above as XXX unit, XXX means, etc.).

The present invention is not limited to the above-mentioned embodiments, and can be changed as appropriate within the range not departing from the gist of the present invention. The processing described in the above-mentioned embodiments may be executed not only in chronological order but also in parallel or individually according to the processing capability or necessity of the device executing the process.

As described above, when the processing functions of the hardware entity (the device of the invention) described in the above embodiment are implemented by a computer, the processing contents of the functions that the hardware entity should have are described by a program. Then, by executing this program on a computer, the processing functions of the above hardware entity are implemented on the computer.

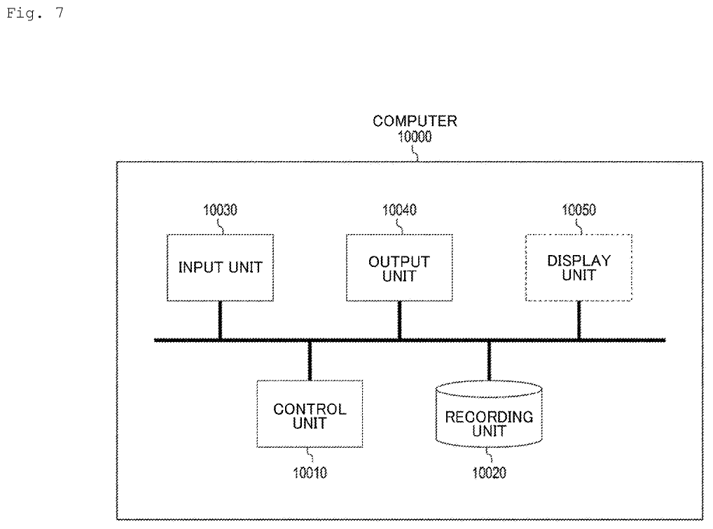

The various processes described above can be implemented by loading a program that executes each step of the above-mentioned method into the recording unit 10020 in the computer illustrated in FIG. 7, and causing the control unit 10010, the input unit 10030, the output unit 10040, etc. to operate.

The program describing the processing contents can be recorded on a recording medium that can be read by a computer. For example, a magnetic recording device, optical disk, magneto-optical recording medium, semiconductor memory, etc. can be used as a computer-readable recording medium. Specifically, for example, a hard disk drive, flexible disk, or magnetic tape, etc. can be used as a magnetic recording device; DVD (Digital Versatile Disc), DVD-RAM (Random Access Memory), CD-ROM (Compact Disc Read Only Memory), or CD-R (Recordable)/RW (ReWritable), etc. can be used as an optical disk; MO (Magneto-Optical disc), etc. can be used as an optical magnetic recording medium; and EEP-ROM (Electrically Erasable and Programmable-Read Only Memory), etc. can be used as a semiconductor memory.

The program is distributed by, for example, selling, transferring, or lending a portable recording medium such as a DVD or CD-ROM that contains the program. Furthermore, the program may be stored in a storage device in a server computer, and transferred from the server computer to another computer through a network, so that the program is distributed.

A computer executing such a program, for example, first stores the program recorded on a portable recording medium or transferred from a server computer in its own storage device. Then, when executing the process, the computer reads the program stored in its own storage media and executes the process according to the read program. As another form of execution of the program, the computer may read the program directly from the portable recording medium and execute the processing according to the program. In addition, whenever a program is transferred from the server computer to this computer, the computer may execute processing according to the received program. The computer may also be configured to execute the above-mentioned processing by a so-called ASP (Application Service Provider) type service that does not transfer the program from the server computer to this computer, but implements processing functions only by executing instructions and obtaining results. The program in this form includes information that is used for processing by the computer and is equivalent to a program (data, etc. that is not a direct command to the computer, but has properties that define the computer processing).

In this form, the hardware entity is configured by executing a predetermined program on a computer, but at least part of these processing contents may be implemented in hardware.

1. An abnormal data generation device comprising a processor configured to execute a method comprising:
generating pseudo generated data of abnormal data, which has, in the same latent space, a normal distribution as a normal data generation model and an abnormal distribution expressed as a complementary set of the normal distribution and is optimized such that pseudo generated data excludes being discriminated from observed actual abnormal data by a latent variable sampled from the abnormal distribution.

2. The abnormal data generation device according to claim 1, the processor is further configured to execute a method comprising:
encoding and decoding observed data including observed abnormal data by an autoencoder type deep neural network to generate reconstructed data of abnormal data optimized such that pseudo generated data excludes being discriminated from observed actual abnormal data.

3. The abnormal data generation device according to claim 1, wherein the generating uses a decoder for generating the pseudo generated data, in which a parameter is updated and trained such that the cost function that becomes smaller as a classifier for discriminating whether input abnormal data is observed abnormal data makes a more correct decision becomes larger.

4. An abnormal data generation model learning device comprising a processor configured to execute a method comprising:
acquiring observed data including observed normal data and observed abnormal data, and encoding and decoding the observed data by an autoencoder type deep neural network to acquire reconstructed data of normal data and abnormal data;
acquiring pseudo generated data of the normal data and pseudo generated data of the abnormal data on the basis of a complementary-set variational autoencoder; and
updating, on the basis of an adversarial complementary-set variational autoencoder obtained by combining a complementary-set variational autoencoder and a generative adversarial network, a parameter of a classifier for discriminating whether input data is the observed data and parameters of an encoder and a decoder for reconstruction and pseudo generation.

5. The abnormal data generation model learning device according to claim 4, the processor is further configured to execute a method comprising:
acquiring pseudo generated data of normal data on the basis of randomly generated latent variables from the probability distribution of latent variables trained to have a small difference from the standard Gaussian distribution;
acquiring pseudo generated data of abnormal data on the basis of randomly generated latent variables from the probability distribution of latent variables trained to have a small difference from the complementary-set distribution of normal data;
acquiring a determination result by inputting the observed data, the reconstructed data, and the pseudo generated data to a classifier for discriminating whether input data is the observed data;
updating a parameter of the classifier such that a cost function that becomes smaller as the classifier makes a more correct decision becomes smaller; and
updating parameters of an encoder and a decoder for reconstruction and pseudo generation such that the cost function becomes larger.

6. A computer implemented method for generating an abnormal data, comprising
generating pseudo generated data of abnormal data that has, in the same latent space, a normal distribution as a normal data generation model and an abnormal distribution expressed as a complementary set of the normal distribution and that is optimized such that pseudo generated data cannot be discriminated from observed actual abnormal data by a latent variable sampled from the abnormal distribution.

7-8. (canceled)

9. The abnormal data generation device according to claim 1, wherein the abnormal data is associated with an audio signal.

10. The abnormal data generation device according to claim 1, wherein the abnormal data is associated with one or more pixels of image data.

11. The abnormal data generation device according to claim 3, wherein the generating uses a decoder for generating the pseudo generated data, in which a parameter is updated and trained such that the cost function that becomes smaller as a classifier for discriminating whether input abnormal data is observed abnormal data makes a more correct decision becomes larger.

12. The abnormal data generation model learning device according to claim 4, wherein the abnormal data is associated with an audio signal.

13. The abnormal data generation device according to claim 4, wherein the abnormal data is associated with one or more pixels of image data.

14. The computer implemented method according to claim 6, further comprising:
encoding and decoding observed data including observed abnormal data by an autoencoder type deep neural network to generate reconstructed data of abnormal data optimized such that pseudo generated data excludes being discriminated from observed actual abnormal data.

15. The computer implemented method according to claim 6, wherein the abnormal data is associated with an audio signal.

16. The computer implemented method according to claim 6, wherein the abnormal data is associated with one or more pixels of image data.

17. The computer implemented method according to claim 6, wherein the generating uses a decoder for generating the pseudo generated data, in which a parameter is updated and trained such that the cost function that becomes smaller as a classifier for discriminating whether input abnormal data is observed abnormal data makes a more correct decision becomes larger.

18. The computer implemented method according to claim 14, wherein the generating uses a decoder for generating the pseudo generated data, in which a parameter is updated and trained such that the cost function that becomes smaller as a classifier for discriminating whether input abnormal data is observed abnormal data makes a more correct decision becomes larger.
